(19) United States
(12) Patent Application Publication
(10) Pub. No.: US 2012/0087786 A1
(43) Pub. Date: Apr. 12, 2012

(54) Stator Structure of Turbo Molecular Pump and Method for Manufacturing the Same

(75) Inventors: Kuo-Hsun Hsu, Hsinchu (TW); Chao-Huan Li, Hsinchu (TW); Wei-Cheng Tai, Hukou Township (TW); Chih-Neng Hsu, Nantou City (TW); Hsiao-Wei D. Chiang, Hsinchu (TW)

(73) Assignee: PROSOL CORPORATION, Zhubei City (TW)

(21) Appl. No.: 13/073,010

(22) Filed: Mar. 28, 2011

(30) Foreign Application Priority Data
Oct. 8, 2010 (TW) 099134402

(51) Int. Cl. F01D 9/04; B23Q 11/00

(52) U.S. Cl. 415/199.4; 409/131

(57) ABSTRACT

The present invention discloses an improved stator structure of a turbo molecular pump and a method for manufacturing the same. The stator comprises a plurality of stator blade assemblies, and each stator blade assembly comprising an inner shroud ring, an outer shroud ring and a plurality of stator blades, wherein the inner shroud ring, the outer shroud ring and the plurality of stator blades are integrated so that the rigidity of the stator is increased and the stator is not easily to be deformed; the method for manufacturing the stator comprises the steps of: laying a raw material on a computer numerical control (CNC) lathe; proceeding an outline treatment to a shape of each stator blade assembly by a turnery process; and shaping the plurality of stator blades of each stator blade assembly with a five-axis processing machine.

### BACKGROUND OF THE INVENTION

1. Field of the Invention

The present invention relates to an improved stator structure of a turbo molecular pump and a method for manufacturing the same, and more particularly to a stator structure which comprises integrated stator blades and shroud rings and a method for manufacturing the same.

2. Description of the Prior Art

In recent years, semiconductor industries are developed rapidly, so that the requirement of the related apparatuses in front-end stage of the semiconductor is largely increased, and wherein a turbo molecular pump, the major device in the high vacuum system, has a great demand.

The turbo molecular pump is originated in 1912 and improved from a molecular drag pump invented by a German, Gaede. Referring to FIG. 1, which is a cross-sectional view of a conventional turbo molecular pump. The conventional turbo molecular pump A includes a rotor A1 and a stator A2, wherein the rotor A1 includes a rotor shaft A10 and a plurality of rotor blades A11, and the stator A2 includes a plurality of stator blades A21. The rotor blades A11 and the stator blades A21 are disposed in a staggered manner layer by layer.

Referring to FIG. 2, which is a schematic diagram of an action principle of a turbo molecular pump. After a gas molecule B5 entering the turbo molecular pump B1, the gas molecule B5 get into next level of stator blade B3 driven by a rotor blade B2, as indicated by the dotted line. Following, the gas molecule B5 rams the stator blade B3 and turns its forward direction, and then gets into the next level of rotor blade B4. Therefore, the action principle of the turbo molecular pump is to make the gas molecules originally having chaotic movement in the system move forward an exit by inclined blades with high-speed rotation, and to elevate a compression ratio by the staggered arrangement of multi-level rotor blades and stator blades. Owing to the turbo molecular pump has the property of high vacuum, high exhaust efficiency and no oil pollution, the turbo molecular pump is widely used on various researches and applications.

In a conventional stator blade assembly, each stator blade is usually formed on a raw material by the way of punch and bending, and the stator blade assembly is connected with an outer ring which is used to connect with other outer rings of other stator blade assemblies. However, the rigidity of the stator blades formed by bending is poor, and the stator blades are easily deformed through contacting with gas in high-speed movement continuously, so as to decrease the working efficiency of the turbo molecular pump and even to cause the damage of the turbo molecular pump.

In view of this, it is necessary to provide an improved stator structure of a turbo molecular pump and a method for manufacturing the same, which can increase the whole rigidity of the stator blade assembly and elevate the working efficiency and the life of the turbo molecular pump.

### SUMMARY OF THE INVENTION

In view of the above shortcomings of the prior art, the inventor of the present invention resorted to past experience, imagination, and creativity, performed experiments and researches repeatedly, and eventually devised the present invention, an improved stator structure of a turbo molecular pump and a method for manufacturing the same.

The major objective of the present invention is to provide the improved stator structure of the turbo molecular pump, which can increase the whole rigidity by the integrated structure of an inner shroud ring, an outer shroud ring and a plurality of stator blades of each level of stator blade assembly, so as to make the stator blades not to be deformed easily, and decrease the complexity and working time in fabrication.

According to the above objective, the present invention provides the improved stator structure of the turbo molecular pump, wherein the stator comprises a plurality of stator blade assemblies, and each stator blade assembly comprising: an inner shroud ring being disposed on the inner side of the stator blade assembly; an outer shroud ring being disposed on the outer side of the stator blade assembly and assisting in the combination of the stator blade assembly with adjacent ones; and a plurality of stator blades being radially disposed between the inner shroud ring and the outer shroud ring, wherein the plurality of stator blades are arranged with uniform spacing; wherein the inner shroud ring, the outer shroud ring and the plurality of stator blades are integrated so that the rigidity of the stator is increased and the stator is not easily to be deformed.

Another objective of the present invention is to provide the method for manufacturing the improved stator structure of the turbo molecular pump, which can increase the whole rigidity by a computer numerical control (CNC) lathe and a milling process with a five-axis processing machine for manufacturing an integrated stator blade assembly, so as to make the stator blades not to be deformed easily, and decrease the complexity and working time in fabrication.

According to the above objective, the present invention provides the method for manufacturing the improved stator structure of the turbo molecular pump comprising the steps of: (1) laying a raw material of each stator blade assembly on a computer numerical control (CNC) lathe, and fixing the position of the raw material; (2) proceeding an outline treatment to a shape of each stator blade assembly by a turnery process with the CNC lathe; and (3) shaping a plurality of stator blades of each stator blade assembly by a milling process with a five-axis processing machine.

### BRIEF DESCRIPTION OF THE DRAWINGS

For a complete understanding of the aspects, structures and techniques of the invention, reference should be made to the following detailed description and accompanying drawings wherein:

FIG. 1 is a cross-sectional view of a conventional turbo molecular pump;

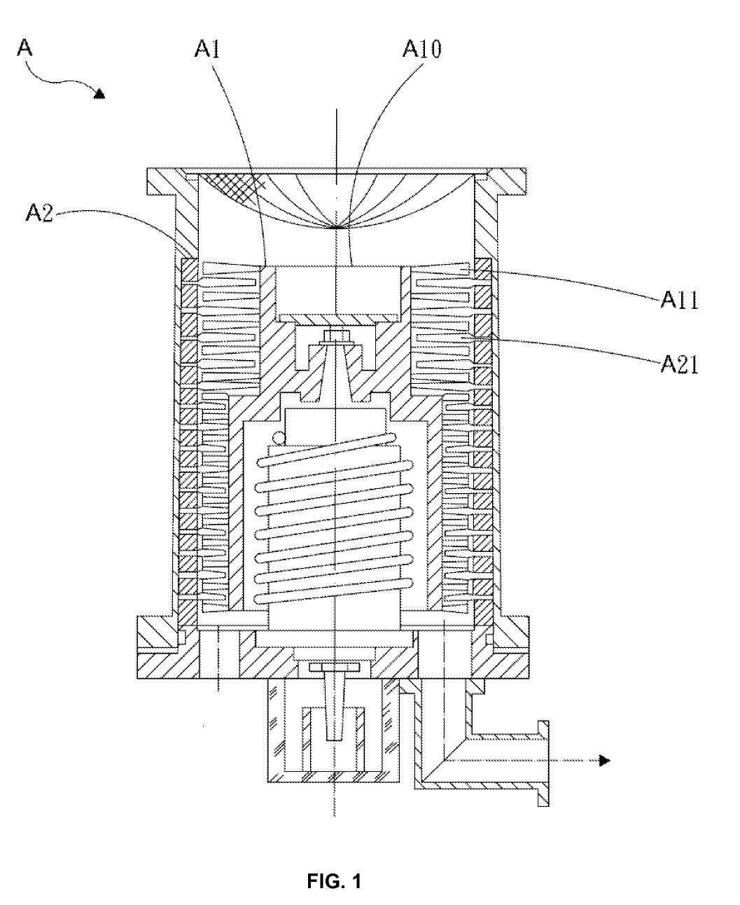

FIG. 2 is a schematic diagram of an action principle of a turbo molecular pump;

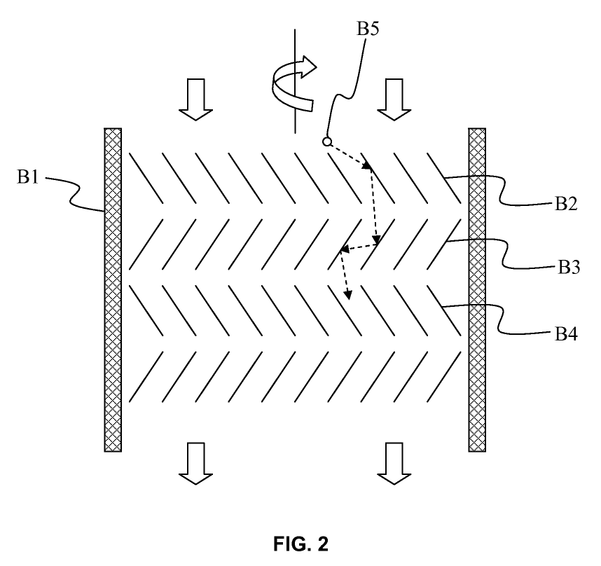

FIG. 3 is a perspective view of a stator of a turbo molecular pump of the present invention;

FIG. 4 is a flow chart diagram of a method for manufacturing the improved stator structure of the turbo molecular pump of the present invention;

FIG. 5 is a detailed flow chart diagram of a milling process of a five-axis processing machine of the present invention;

FIG. 6 is a flow chart diagram of a design for overall appearance and processing path of the present invention; and

FIG. 7 is a flow chart diagram of a processing error analysis of the present invention.

### DETAILED DESCRIPTION OF THE PREFERRED EMBODIMENTS

To achieve the foregoing objectives and effects, the inventors utilize a serious of processes for manufacturing an integrated stator blade assembly, and modify the stator blade assembly repeatedly, thus achieving an improved stator structure of a turbo molecular pump and a method for manufacturing the same of the present invention.

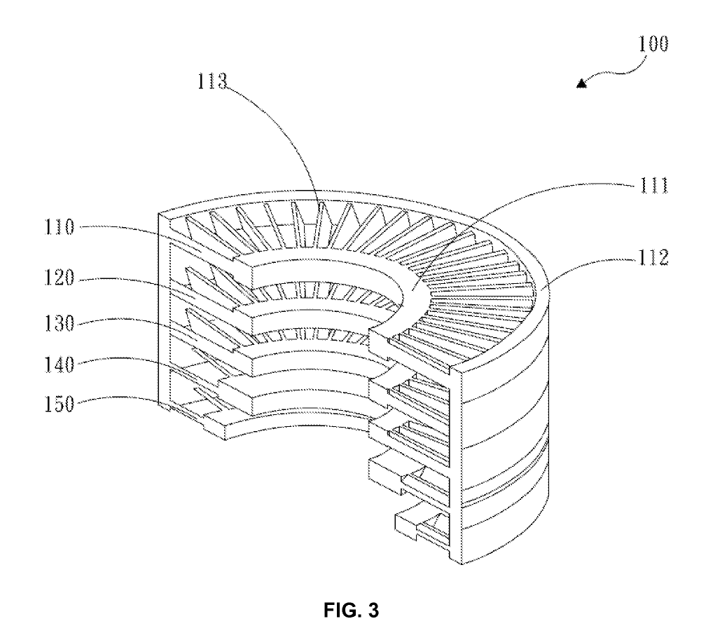

Referring to FIG. 3, which is a perspective view of a stator of a turbo molecular pump of the present invention. The stator 100 includes a plurality of stator blade assemblies 110, 120, 130, 140, and 150, and each stator blade assembly, take 110 as the example, includes: an inner shroud ring 111 being disposed on the inner side of the stator blade assembly 110; an outer shroud ring 112 being disposed on the outer side of the stator blade assembly 110 and assisting in the combination of the stator blade assembly 110 with adjacent ones (120, 130, 140, and 150); and a plurality of stator blades 113 being radially disposed between the inner shroud ring 111 and the outer shroud ring 112, wherein the plurality of stator blades 113 are arranged with uniform spacing; wherein the inner shroud ring 111, the outer shroud ring 112 and the plurality of stator blades 113 are integrated so that the rigidity of the stator 100 is increased and the stator 110 is not easily to be deformed. The best material of the stator 100 is Al 7050 aluminum, and the material can be substituted by aluminum alloy, copper, gold, steel, iron, cast iron, or stainless steel.

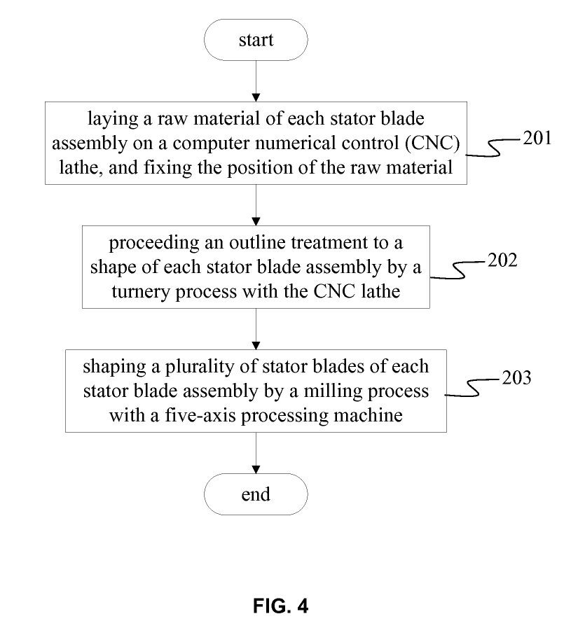

Referring to FIG. 4, which is a flow chart diagram of a method for manufacturing the improved stator structure of the turbo molecular pump of the present invention. The method includes the steps of: (step 201) laying a raw material of each stator blade assembly on a computer numerical control (CNC) lathe, and fixing the position of the raw material, wherein the raw material is a cylindrical material; (step 202) proceeding an outline treatment to a shape of each stator blade assembly by a turnery process with the CNC lathe; and (step 203) shaping a plurality of stator blades of each stator blade assembly by a milling process with a five-axis processing machine.

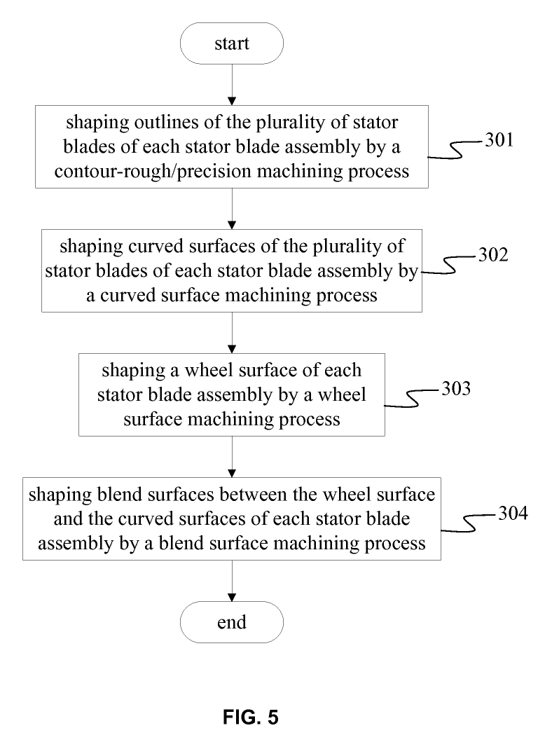

The above step 203 can be subdivided into several steps. Referring to FIG. 5, which is a detailed flow chart diagram of a milling process of a five-axis processing machine of the present invention. The milling process includes the steps of: (step 301) shaping outlines of the plurality of stator blades of each stator blade assembly by a contour-rough/precision machining process; (step 302) shaping curved surfaces of the plurality of stator blades of each stator blade assembly by a curved surface machining process, wherein the curved surface machining process employs the rule of equal altitude in a fan-shaped for planning the path of the cutting tools, and the processing region is divided into upper suction surface and lower pressure surface, wherein the curved surface of the upper suction surface is processed prior to the curved surface of the lower pressure surface, and the curved surface of the trailing edge of the blades are processed finally, wherein the cascade of the processing path employs the reciprocating manner; (steps 303) shaping a wheel surface of each stator blade assembly by a wheel surface machining process, wherein the wheel surface machining process adopts a mixing process of a side milling process and an end milling process, and the processing region is subdivided into a side milling area and a end milling area, wherein the side milling area is further divided into a upper sub-region and a lower sub-region; and (step 304) shaping blend surfaces between the wheel surface and the curved surfaces of each stator blade assembly by a blend surface machining process, wherein the step can connect the wheel and the blades smoothly so as to increase the strength and the efficiency of the blades

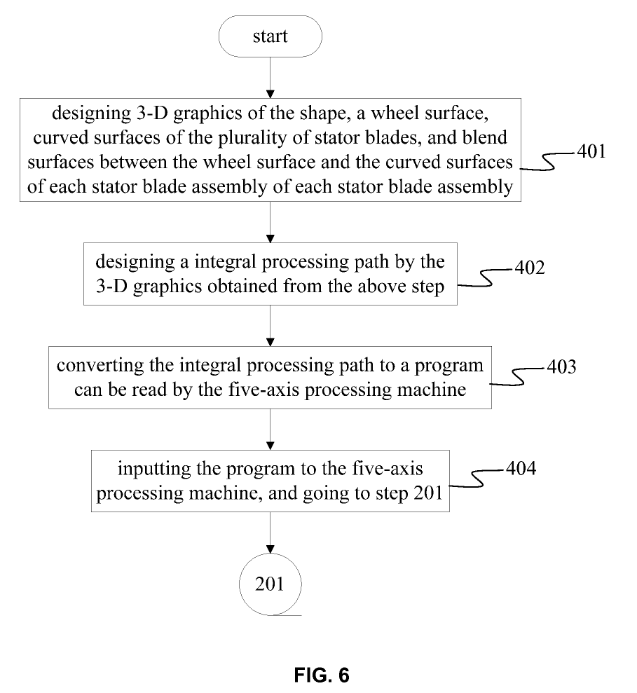

Furthermore, before entering the above step 201, it is necessary to design the overall appearance of the stator blade assembly and the processing path. Referring to FIG. 6, which is a flow chart diagram of a design for overall appearance and processing path of the present invention. It includes the steps of: (step 401) designing 3-D graphics of the shape, a wheel surface, curved surfaces of the plurality of stator blades, and blend surfaces between the wheel surface and the curved surfaces of each stator blade assembly of each stator blade assembly, wherein the step is achieved by a computer-aided design (CAD) software; (step 402) designing a integral processing path by the 3-D graphics obtained from the above step, wherein the step is achieved by a computer-aided manufacturing (CAM) software; (step 403) converting the integral processing path to a program can be read by the five-axis processing machine; and (step 404) inputting the program to the five-axis processing machine, and going to step 201.

Moreover, after finishing the above step 203, a processing error analysis can be employed for knowing that whether the product manufactured by the above process is the same with the original designed model. This processing error analysis is generally achieved by a Coordinate Measuring Machine (CMM) for examining the product, and then comparing the measured curved surface of the product with the curved surface of the original designed model, so as to obtain the difference of a specific position on the outline between the two surfaces. Regarding the error of scallop high or brace high of the curved surface of the product caused by the process, that should be measured by a roughness tester which can measure the roughness of a curved surface.

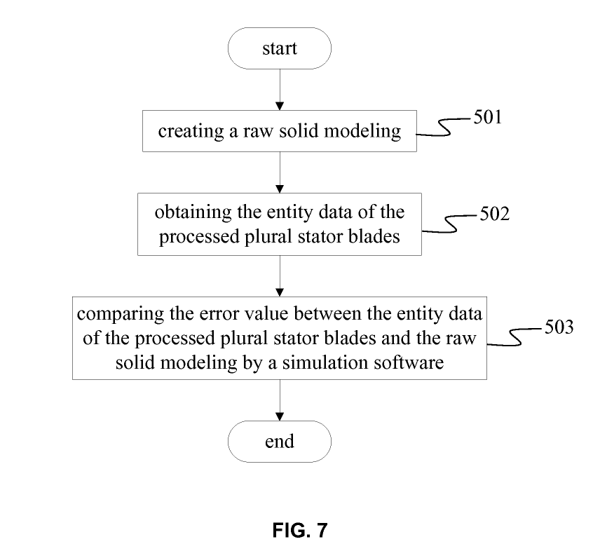

Referring to FIG. 7, which is a flow chart diagram of a processing error analysis of the present invention. It includes the steps of: (step 501) creating a raw solid modeling; (step 502) obtaining the entity data of the processed plural stator blades; and (step 503) comparing the error value between the entity data of the processed plural stator blades and the raw solid modeling by a simulation software.

By the detailed description of the overall structure and technical content of the present invention, the following advantages of the present invention can be derived:

The integrated stator provided by present invention can increase the overall rigidity, and the stator blades can maintain the original configuration and not to be deformed easily after the constant working of the turbo molecular pump, so as to increase the life and the efficiency of the stator.

The integrated stator of the present invention can decrease the complexity in fabrication by its simple structure, so as to reduce the fabrication time.

The present invention employs a serious of computer-controlling process for manufacturing an accurate stator with less time, so as to remit the traditional time-consuming and complicated manufacturing process.

It should be understood that the embodiments of the present invention described herein are merely illustrative of the technical concepts and features of the present invention and are not meant to limit the scope of the invention. Those skilled in the art, after reading the present disclosure, will know how to practice the invention. Various variations or modifications can be made without departing from the spirit of the invention. All such equivalent variations and modifications are intended to be included within the scope of the invention.

As a result of continued thinking about the invention and modifications, the inventors finally work out the designs of the present invention that has many advantages as described above. The present invention meets the requirements for an invention patent, and the application for a patent is duly filed accordingly. It is expected that the invention could be examined at an early date and granted so as to protect the rights of the inventors.

What is claimed is:

1. An improved stator structure of a turbo molecular pump, wherein the stator comprises a plurality of stator blade assemblies, and each stator blade assembly comprising:
an inner shroud ring being disposed on the inner side of the stator blade assembly;
an outer shroud ring being disposed on the outer side of the stator blade assembly and assisting in the combination of the stator blade assembly with adjacent ones; and
a plurality of stator blades being radially disposed between the inner shroud ring and the outer shroud ring, wherein the plurality of stator blades are arranged with uniform spacing;
wherein the inner shroud ring, the outer shroud ring and the plurality of stator blades are integrated so that the rigidity of the stator is increased and the stator is not easily to be deformed.

2. The improved stator structure of the turbo molecular pump according to claim 1, wherein the material of the stator is selected from the group consisting of: Al 7050 aluminum, aluminum alloy, copper, gold, steel, iron, cast iron, and stainless steel.

3. A method for manufacturing an improved stator structure of a turbo molecular pump comprising the steps of:
(1) laying a raw material of each stator blade assembly on a computer numerical control (CNC) lathe, and fixing the position of the raw material;
(2) proceeding an outline treatment to a shape of each stator blade assembly by a turnery process with the CNC lathe; and
(3) shaping a plurality of stator blades of each stator blade assembly by a milling process with a five-axis processing machine.

4. The method for manufacturing the improved stator structure of the turbo molecular pump according to claim 3, wherein the raw material is a cylindrical material.

5. The method for manufacturing the improved stator structure of the turbo molecular pump according to claim 3, wherein the milling process of step (3) further comprising the steps of:
(3.1) shaping outlines of the plurality of stator blades of each stator blade assembly by a contour-rough/precision machining process;
(3.2) shaping curved surfaces of the plurality of stator blades of each stator blade assembly by a curved surface machining process;
(3.3) shaping a wheel surface of each stator blade assembly by a wheel surface machining process; and
(3.4) shaping blend surfaces between the wheel surface and the curved surfaces of each stator blade assembly by a blend surface machining process.

6. The method for manufacturing the improved stator structure of the turbo molecular pump according to claim 3, wherein before starting step (1), the method further comprising the steps of:
(a) designing 3-D graphics of the shape, a wheel surface, curved surfaces of the plurality of stator blades, and blend surfaces between the wheel surface and the curved surfaces of each stator blade assembly of each stator blade assembly;
(b) designing a integral processing path by the 3-D graphics obtained from step (a);
(c) converting the integral processing path to a program can be read by the five-axis processing machine; and
(d) inputting the program to the five-axis processing machine, and going to step (1).

7. The method for manufacturing the improved stator structure of the turbo molecular pump according to claim 6, wherein step (a) is achieved by a computer-aided design (CAD) software.

8. The method for manufacturing the improved stator structure of the turbo molecular pump according to claim 6, wherein step (b) is achieved by a computer-aided manufacturing (CAM) software.

9. The method for manufacturing the improved stator structure of the turbo molecular pump according to claim 3, wherein after finishing step (3), the method further comprising the steps of:
(a) creating a raw solid modeling;
(b) obtaining the entity data of the processed plural stator blades; and
(c) comparing the error value between the entity data of the processed plural stator blades and the raw solid modeling by a simulation software.
